(19) United States
(12) Patent Application Publication
(10) Pub. No.: US 2017/0294818 A1
(43) Pub. Date: Oct. 12, 2017

(54) BRUSHLESS MOTOR

(71) Applicant: Kai-Lun Lin, Taichung City (TW)

(72) Inventor: Kai-Lun Lin, Taichung City (TW)

(73) Assignee: Imakawa Technology Co,.LTD., Taichung City (TW)

(21) Appl. No.: 15/097,038

(22) Filed: Apr. 12, 2016

(51) Int. Cl. H02K 3/42; H02K 16/02; H02K 1/16; H02K 1/02; H02K 1/27

(52) U.S. Cl. CPC H02K 3/42; H02K 1/02; H02K 1/27; H02K 1/16; H02K 16/02

(57) ABSTRACT

A brushless motor may be applied to an aircraft or a drone and have a stable structure with long life. The efficiency of the brushless motor can reach 94-98% to solve the problems of power consumption during flight and to save energy. Also, the brushless motor has a light-weight body which allows the aircraft to carry more freight.

### FIELD OF THE INVENTION

The present invention relates to a brushless motor and more particularly to a brushless motor with durable life and high reliability.

### BACKGROUND OF THE INVENTION

Generally, an unmanned aerial vehicle, also known as a drone, is configured to be operated in the manner of remote control to achieve assignments such as geological exploration without a pilot. In the past, the drone only can be operated in the line of sight of operator. However, lately, the drone, through a variety of methods, is applied in the fields of sensors, transportations, carrying freight and weapons. Moreover, the drone is advantageous because of its low operating cost, high mobility, wide applicability, etc. In general, the drone can be divided into three main categories which are miniature drone, micro drone and military-specific drone.

The main factor which determines the flight efficiency of the drone is motor, meaning that the efficiency of motor can directly affect the flight performance of the drone, and there are two major problems may occur in the use and manufacturing of the motor: (i) typically, a conventional drone is equipped with a carbon brush motor or a series-wound motor which are disadvantageous due to their big size, heavy weight, and low efficiency (<65%) caused by their two-phase motor structure. In the past five years, a new type of motor, three-phase brushless DC motor, is applied to improve the problems mentioned above. However, when motor activated, since an angle between the direction of switching the phase and the direction of the flux of cogging torque is 90 degrees, the efficiency of this kind of motor are limited. For now, the best efficiency of the three-phase brushless DC motor is around 75%, and in order to enhance the efficiency to reach 85% or more, the motor needs to use specific advanced materials which increases the cost and the difficulty of manufacturing; and (ii) most brushless DC motors in the market adopt a traditional manual winding approach, which also limits the efficiency of the motor. Therefore, there remains a need for a new and improved design for a brushless motor to overcome the problems presented above.

### SUMMARY OF THE INVENTION

The present invention provides a brushless motor which comprises a main body, two rotors, a stator and a plurality of teeth. The main body has a first cover and a second cover which are configured to connect to each other to separate an accommodating space therebetween. The two rotors are respectively coupled with a bottom surface of the first cover and a top surface of the second cover, and each of the two rotors has a donut hole formed at a central portion thereof, and a plurality of permanent magnets are positioned around each of the donut hole. Then, when the main body connected to the stator, each of the two rotors can be rotated above a top surface and below a bottom surface of the stator respectively. Also, each of central portions of the first cover and the second cover has a through hole. The stator comprises a lamination, and a plurality of slots formed at an outer periphery thereof are configured to receive and engage with the teeth. Also, the lamination further comprises a tube formed at a central portion thereof. After windings are wound around the teeth, the stator is positioned into the accommodating space between the two covers to allow an upper portion and a lower portion of the tube to upwardly and downwardly protrude from each of the two through holes of the first cover and the second cover respectively. Moreover, two bearings, which are respectively disposed between the upper portion of the tube and the through hole on the first cover and between the lower portion of tube and the through hole on the second cover, are configured to allow the tube to rotate about the through holes. Each of grooves formed at a central portion of the tooth is configured to be received and secured in the slot of the stator. Also, each of the teeth has two blocking portions, upper blocking portion and lower blocking portion, formed at an upper end and a lower end thereof, and two coil receiving portions, upper coil receiving portion and lower coil receiving portion, are respectively formed between the upper blocking portion and the groove, and between the lower blocking portion and the groove. The winding is wound upwardly or downwardly around the coil receiving portions of each of the teeth to form into a coil, and the winding process includes successively winding each of the teeth with a continuous winding wire. Also, after winding around a single tooth, the winding wire is horizontally extended to an adjacent tooth to continue upward or downward winding process to form a three-phase motor.

Comparing with conventional motor, the present invention is advantageous because: (i) by applying particular winding structure and stator core, the magnetic field of the motor and the electric field generated by the windings are in the same direction when motor activated, so that the direction of the eddy current generated by electromagnetic induction is in horizontal direction thereby reducing the probability of eddy current losses when motor switching the phase, saving the energy, increasing the torsion of motor and improving the flight time of a drone. Also, the brushless motor of the present invention can provide higher power density because it has thirty-six slots which is four times of the conventional motors which only have nine slots. Thus, the distance between each of two slots in the present invention is shorter by four times, compared to the conventional motors, resulting in achieving the efficiency of the motor to 94-98%; and (ii) the automatic winding method and the technology of permanent-magnet synchronous motor which are applied in the present invention can lower the cost of manufacturing and labor, and allow the present invention to have wider applications thereby enhancing market competitiveness.

### BRIEF DESCRIPTION OF THE DRAWINGS

FIG. 1 is a three-dimensional assembly view of a brushless motor in the present invention.

FIG. 2 is a three-dimensional exploded view of the brushless motor in the present invention.

FIG. 3 is a partial exploded view illustrating a stator and teeth of the brushless motor in the present invention.

FIG. 4 is a plane assembly view of the brushless motor in the present invention.

FIG. 5 is a sectional view taken along line A-A of FIG. 4.

FIG. 6 is a sectional view taken along line B-B of FIG. 4.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

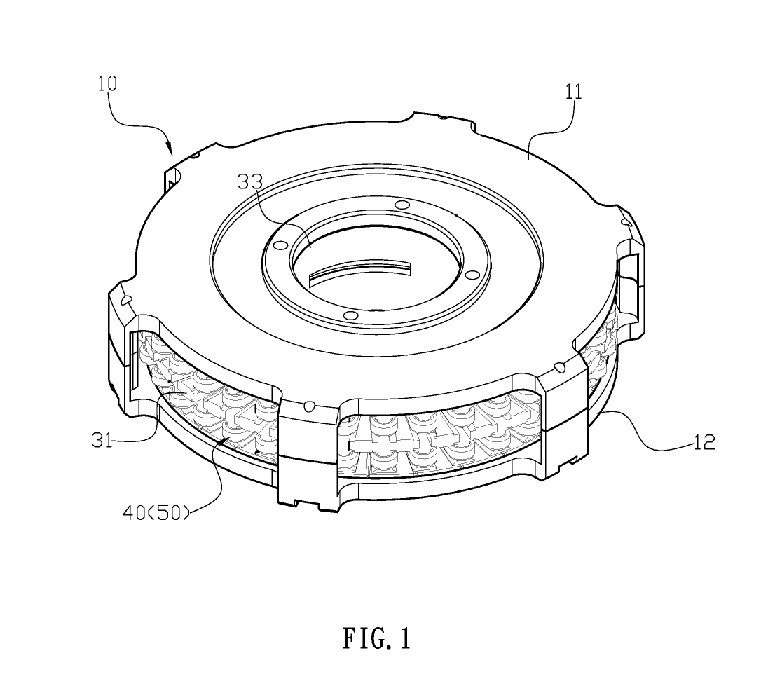

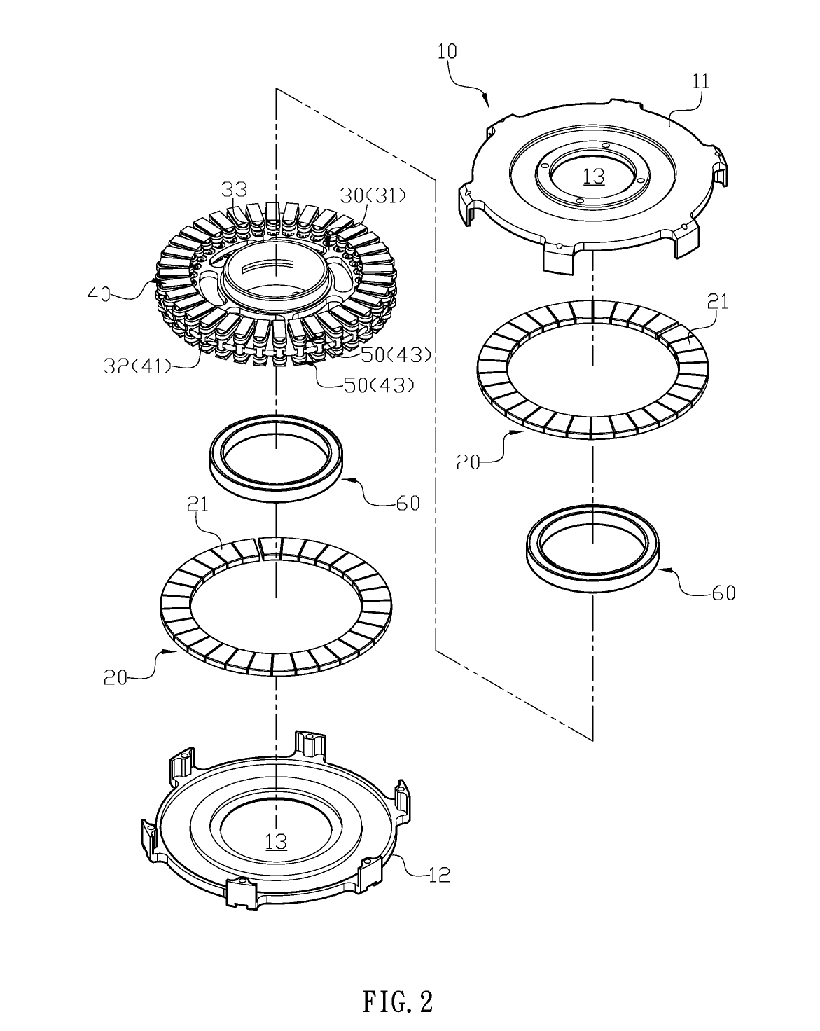

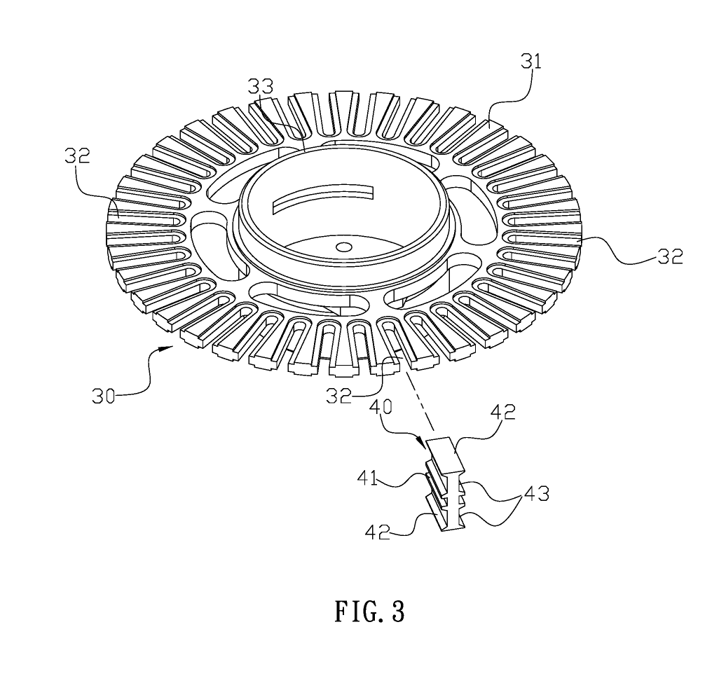

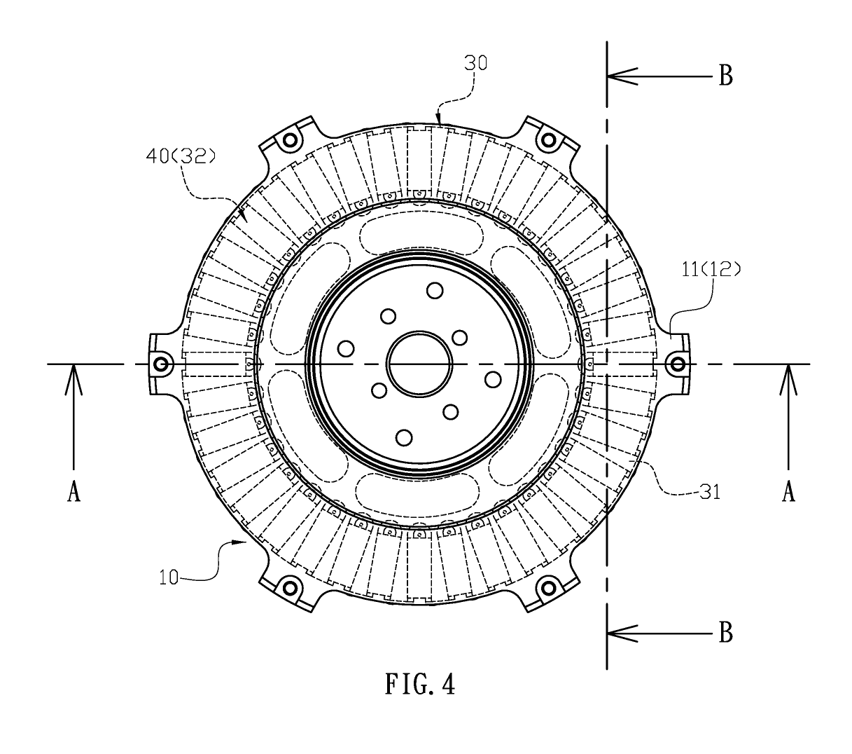

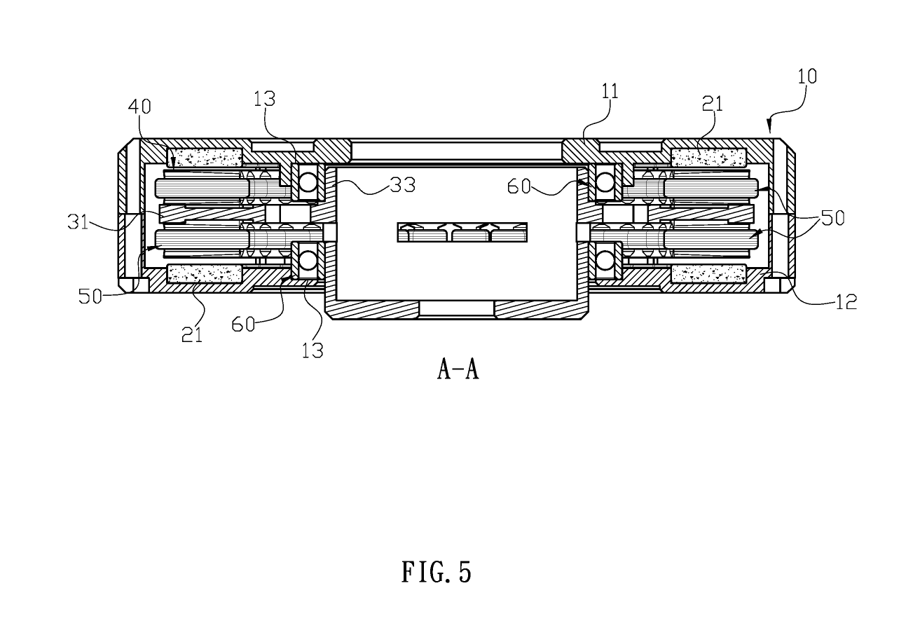

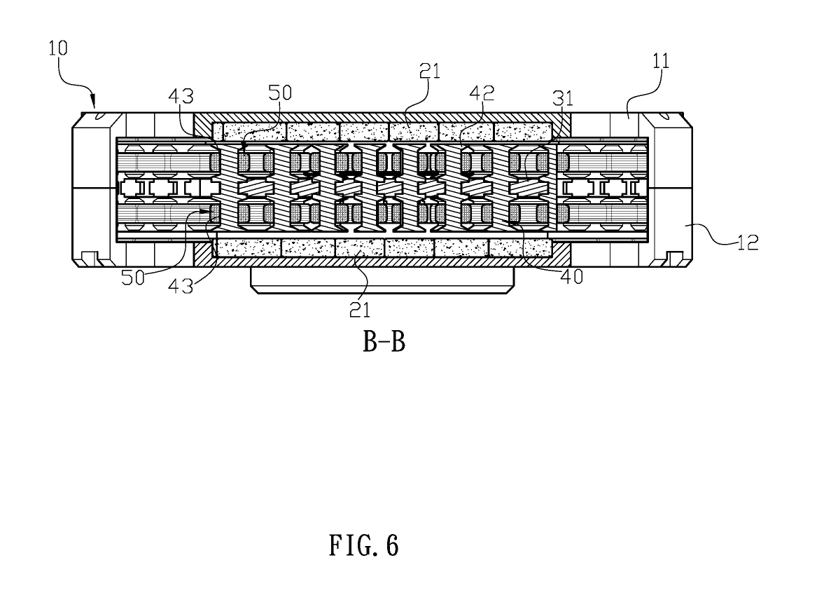

Referring to FIGS. 1 to 6, the present invention provides a brushless motor which comprises a main body (10), two rotors (20), a stator (30) and a plurality of teeth (40). The main body (10) has a first cover (11) and a second cover (12) which are configured to connect to each other to separate an accommodating space therebetween. The two rotors (20) are respectively coupled with a bottom surface of the first cover (11) and a top surface of the second cover (12), and each of the two rotors (20) has a donut hole formed at a central portion thereof, and a plurality of permanent magnets (21) are positioned around each of the donut holes. Then, when the main body (10) connected to the stator (30), each of the two rotors (20) can be rotated above a top surface and below a bottom surface of the stator (30) respectively. Also, each of central portions of the first cover (11) and the second cover (12) has a through hole (13). The stator (30) comprises a lamination (31), and a plurality of slots (32) formed at an outer periphery thereof are configured to receive and engage with the teeth (40). Also, the lamination (31) further comprises a tube (33) formed at a central portion thereof. After windings (50) are wound around the teeth (40), the stator (30) is positioned into the accommodating space between the two covers (11)(12) to allow an upper portion and a lower portion of the tube (33) to upwardly and downwardly protrude from each of the two through holes (13) of the first cover (11) and the second cover (12) respectively. Moreover, two bearings (60), which are respectively disposed between the upper portion of the tube (33) and the through hole (13) on the first cover (11) and between the lower portion of tube (33) and the through hole (13) on the second cover (12), are configured to allow the tube (33) to rotate about the through holes (13). Each of grooves (41) formed at a central portion of the tooth (40) is configured to be received and secured in each of the slots (32) of the stator (30). Also, each of the teeth (40) has two blocking portions (42), upper blocking portion (42) and lower blocking portion (42), formed at an upper end and a lower end thereof, and two coil receiving portions (43), upper coil receiving portion (43) and lower coil receiving portion (43), are respectively formed between the upper blocking portion (42) and the groove (41), and between the lower blocking portion (42) and the groove (41). The winding (50) is wound upwardly or downwardly around the coil receiving portions (43) of each of the teeth (40) to form into a coil, and the winding process includes successively winding each of the teeth (40) with a continuous winding wire. Also, after winding around a single tooth (40), the winding wire is horizontally extended to an adjacent tooth (40) to continue upward or downward winding process to form a three-phase motor.

Moreover, the brushless motor in the present invention is referred to as a three-phase brushless motor with thirty-six slots and forty poles, and the winding process is accomplished in a horizontal pattern by the automatic winding machine.

Furthermore, the permanent magnets (21) in the present invention are formed of Samarium-cobalt magnet (SmCo magnet) which can improve the life of the motor, but it also significantly raises the cost of the manufacturing. Thus, the overall qualitative and quantitative evaluation is illustrated as followings: (i) the most widely used type of magnet for a conventional motor is NdFeB which is inexpensive and has high coercivity. However, this kind of magnet tends to be vulnerable to corrosion which leads unfavorable results such as lowering the magnetic flux, causing uneven N/S poles, or further making motor running roughly, such that it needs to add a protective coating such as Electric Trivalent Chromium Coating or Electroless Nickel Coating to prevent exposure to the atmosphere; (ii) the brushless motor in the present invention is applied to a drone or an aircraft such that it must be able to endure harsh weathers to prevent the coating layer from cracking and to pass the aircraft inspections by the Federal Aviation Administration (FAA). Thus, the SmCo magnet which can work in a wide range of temperature is a preferred material for a brushless motor; and (iii) the SmCo magnet is advantageous because it has a strong resistance to corrosion and oxidation, and can be used in high temperature. However, since the SmCo magnet is expensive, the present invention adopts an embodiment which has multi-poles and multi-slots to improve the efficiency of motor and lower the cost and the weight of motor. In addition, the present invention adopts a semi-automatic winding system to reduce the lacks of manual winding such as time-wasting and high labor cost.

Comparing with conventional motor, the present invention is advantageous because: (i) by applying particular winding structure and stator core, the magnetic field of the motor and the electric field generated by the windings (50) are in the same direction when motor activated, so that the direction of the eddy current generated by electromagnetic induction is in horizontal direction thereby reducing the probability of eddy current losses when motor switching the phase, saving the energy, increasing the torsion of motor and improving the flight time of a drone. Also, the brushless motor of the present invention can provide higher power density because it has thirty-six slots which is four times of the conventional motors which only have nine slots. Thus, the distance between each of two slots in the present invention is shorter by four times, compared to the conventional motors, resulting in achieving the efficiency of the motor to 94-98%; and (ii) the automatic winding method and the technology of permanent-magnet synchronous motor which are applied in the present invention can lower the cost of manufacturing and labor, and allow the present invention to have wider applications thereby enhancing market competitiveness.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A brushless motor comprising a main body, two rotors, a stator and a plurality of teeth, wherein:
the main body has a first cover and a second cover which are configured to connect to each other to separate an accommodating space therebetween, the two rotors are respectively coupled with a bottom surface of the first cover and a top surface of the second cover, and each of the two rotors has a donut hole formed at a central portion thereof, and a plurality of permanent magnets are positioned around each of the donut holes, when the main body connected to the stator, each of the two rotors is configured to be rotated above a top surface and below a bottom surface of the stator respectively, and two through holes are respectively formed at each of central portions of the first cover and the second cover;
the stator comprises a lamination, and a plurality of slots formed at an outer periphery thereof are configured to receive and engage with the teeth, and a tube is formed at a central portion of the lamination, after windings are wound around the teeth, the stator is positioned into the accommodating space between the two covers to allow an upper portion and a lower portion of the tube to upwardly and downwardly protrude from each of the two through holes of the first cover and the second cover respectively, two bearings, which are respectively disposed between the upper portion of the tube and the through hole on the first cover and between the lower portion of tube and the through hole on the second cover, are configured to allow the tube to rotate about the through holes; and
each of central portions of the teeth has a groove which is configured to be received and secured in each of the slots of the stator, and each of the teeth has two blocking portions, upper blocking portion and lower blocking portion, respectively formed at an upper end and a lower end thereof, and two coil receiving portions, upper receiving portion and lower receiving portion, are respectively formed between the upper blocking portion and the groove, and between the lower blocking portion and the groove, the winding is wound upwardly or downwardly around the coil receiving portions of each of the teeth to form into a coil, and the winding process includes successively winding each of the teeth with a continuous winding wire, after winding around a single tooth, the winding wire is horizontally extended to an adjacent tooth to continue upward or downward winding process to form a three-phase motor.

2. The brushless motor of claim 1, wherein the brushless motor is a three-phase brushless motor, and the winding process is accomplished in a horizontal pattern by the automatic winding machine.

3. The brushless motor of claim 1, wherein the permanent magnets are formed of Samarium-cobalt magnet (SmCo magnet).
